(19) United States
(12) Patent Application Publication
(10) Pub. No.: US 2007/0169798 A1
(43) Pub. Date: Jul. 26, 2007

(54) Automatic Paint Roller Cover Washer

(76) Inventors: Edwin Todd Barr, Stanley, NC (US); Wayne Steven Lanier, Gastonia, NC (US)

Correspondence Address: Wayne Lanier, 406 Fox Fire Run, Gastonia, NC, 28052, US

(21) Appl. No.: 11/530,470

(22) Filed: Sep. 10, 2006

Related U.S. Application Data
(60) Provisional application No. 60/596,484, filed on Sep. 28, 2005.

(51) Int. Cl. B08B 3/12; B08B 6/00

(52) U.S. Cl. 134/198

(57) ABSTRACT

Disclosed is a device for cleaning paint roller covers. At the end of a painting operation, the operator removes one or more paint roller cover, places them onto a shaft and drops into open slots on the ends of the enclosure. A pressurized fluid hose is attached and allows the fluid to penetrate the entire length of the roller covers. The fluid can be adjusted to direction of the flow to the axis of the roller covers may be used to control the rate of spin and penetration of the fluid into the cover. The adjustment can also be used to optimally direct the fluid flow for smaller trim roller covers to very thick diameter roller covers. The operator may then leave the device operating unattended while it washes and cleans all the paint from the outside surface of the roller covers.

### TECHNICAL FIELD

The present invention relates to a device for conveniently cleaning paint from one or many paint roller covers in an automated fashion.

### BACKGROUND OF THE INVENTION

This invention relates to the automated cleaning of commercial and non-commercial paint roller covers. These covers vary in size both by their cylindrical diameter width and length. The width of the roller cover is determined by the inside opening or core and the thickness of the nap. The nap, which refers to the thickness of the material used to absorb the paint, is important to the type of paint and the surface that is being painted. The thicker the nap the more paint the roller cover can hold, thus allowing penetration of irregular or extremely porous surfaces. Thinner naps soak up less paint and are used to create a very smooth coating of paint on the surface. Lengths may vary from a couple of inches for trim or detailed painting to eighteen inches or more for commercial use.

Another problem that has come about in the past few years is the variety of the type of paint rollers used to paint a single room. There are small rollers for doing trim work, thin nap rollers for smooth surfaces and thick nap rollers for rough surfaces. It has also become typical that multiple colors and textures can be used in the same room. In addition to the variety of type of roller covers, there are also a variety of paint roller handles that are required for different manufacturers of rollers. This means that after a painting job there are several rollers to be cleaned.

One method of cleaning the roller cover is to expend as much paint from the nap surface to the work area as possible. The roller cover is then engaged with a fluid which is used to flush the remaining paint from the nap. As the roller cover is cylindrical and free-wheeling, the above method is at best messy and cumbersome. Any given amount of paint left in the roller cover after cleansing will set up and harden, damaging the roller cover; and, as the roller cover is usually stowed away wet or damp, the damage is not discovered until the roller cover is again placed into service. An additional difficulty with residual paint remaining in the roller cover is making the transition to another color, type of paint which may alter the shade of the new paint and go undetected until the paint dries.

After painting, the manual cleaning of these paint roller covers requires a lengthy clean up time to remove paint that has been absorbed into the nap of the roller. It is most difficult to clean due to the cylindrical nature of its design and the high absorbency of its nap or outer surface. Most professional painters actually constitute roller cleaning as a waste of labor and money. In consequence, the professional is as likely as not to simply discard the roller cover after a first use. The non-professional also tends to avoid the inconvenience of cleanup, because the time it takes to clean a roller outweighs the any cost savings realized from avoiding a new purchase, particularly in view of the long periods of time between paintings.

### DESCRIPTION OF PRIOR ART

To this end, several devices have been proposed to solve the roller cover cleaning problem. For example, several patents describe the cleaning of the paint roller cover while still attached to the paint roller that they were attached to while painting. The problem with this approach is if the painter wants to continue painting while the roller is being clean, he must have additional handles and covers. It also creates a problem with several inventions, because of the different type of handles that are on the market. Most of the existing inventions are made to work with only one type of roller handle and cover. It is also the limitation of these inventions to only be able to clean one roller cover at a time. In the event there is more than one painter working at the same time, multiple of the existing inventions would be required to perform the roller cover cleaning. The prior art that falls into this category are:
U.S. Pat. No. 6,450,185 to Sallinen
U.S. Pat. No. 6,019,111 to Gilles
U.S. Pat. No. 5,932,028 to Carrie
U.S. Pat. No. 5,839,459 to Bisby
U.S. Pat. No. 5,651,381 to Balouchian
U.S. Pat. No. 5,626,158 to Gratopp
U.S. Pat. No. 5,413,133 to Russell
U.S. Pat. No. 5,363,869 to McDowell
U.S. Pat. No. 5,413,133 to Russell
U.S. Pat. No. 5,033,491 to Middleton
U.S. Pat. No. 5,005,598 to Hodgdon
U.S. Pat. No. 4,130,124 to Sherwin
U.S. Pat. No. 4,811,749 to Dixon
U.S. Pat. No. 4,765,354 to Thatcher
U.S. Pat. No. 4,672,987 to Brandt
U.S. Pat. No. 4,641,673 to Conley
U.S. Pat. No. 4,402,333 to Frizzell

Other existing inventions are designed to work by removing the roller cover from the roller handle and inserting them into the invention. There are two categories of inventions. The first category is made in a tubular design that forces water flow down over the roller cover. In the second category, cleaning is accomplished by using pressurize fluid to be sprayed through a plurality of hole on the outer edge of the roller cover causing it to spin. These inventions still have the limitation of being designed to only clean one roller cover at a time and are also made only for one size of roller cover.
U.S. Pat. No. 6,079,429 to Zarich
U.S. Pat. No. 5,487,399 to Hannah
U.S. Pat. No. 5,409,027 to Glunt
U.S. Pat. No. 5,337,769 to Howe
U.S. Pat. No. 5,163,459 to Bailey
U.S. Pat. No. 4,708,152 to Hibberd
U.S. Pat. No. 4,380,478 to Cooney

With the number of inventions in this field, it is still very hard to find any in your local paint store. Many of the inventions are to complex and would require costly manufacturing. Many are too limited to what one length or nap thickness of roller cover they can clean. Many of the inventions do not work effectively and require long cleaning time. These are the issues that this invention is trying to solve.

### SUMMARY OF THE INVENTION

This invention has been developed to automate the cleaning of paint roller covers. The invention may accommodate a variety of different lengths and widths of paint roller covers. After painting, the roller cover is removed from the paint roller and placed onto the invention's roller cleaner shaft. The design accommodates one or multiple (plurality) roller covers simultaneously. The shaft is made to accommodate all sizes of rollers covers. Roller covers with core opening greater than ¼ inches will use an end cap that will allow the cover to be centered on the shaft. After placing the roller cover or covers on the shaft, it is simply dropped into the slots on each end of the enclosure.

A pressurized fluid hose is attached, typically a standard garden water hose pipe, to the side of the device. The fluid passes through a pipe that contains a plurality of holes, spraying the fluid on the entire length of the roller cover with force. This pressurized spray hitting the roller cover at an angle causes the roller cover to spin, thus allowing the fluid to penetrate the roller cover and centrifugally discharge the paint. The fluid pipe in the invention can be turned clockwise or counter clockwise to allow the operator to direct the fluid flow from the outside axis to the center of the roller cover. By directing the flow across the outside axis of the roller, a faster spin may be achieved. Directing the flow closer to the center will allows for deeper penetration of the fluids, but a slower spin. Since roller covers come in a variety of diameters this adjustable is necessary to provide proper cleaning. The excess fluid and paint exits through openings around the bottom of the enclosure.

At this point, the device may be left unattended while the roller cover is cleaned. Time to clean will vary due to thickness of nap, amount of paint, and fluid pressure. If the operator is planning on not coming back for an extended period of time, an off-the-shelve hose timer may be placed between the incoming pressurized fluid hose and the invention to allow a length of time to be set for the fluid flow. After an appropriate amount of time has past, the roller may be inspected and either allow the cleaning process to continue or be stopped.

### BRIEF DESCRIPTION OF THE DRAWINGS

In the drawings like reference numerals are used to indicate identical components in the various figures:

FIG. 1 is a top view of the preferred embodiment showing the relativity of a common paint roller cover placed into the invention.

FIG. 2 is a front view. This perspective shows the drain holes and stake for securing to the ground. It also shows a cross section opening of the invention.

FIG. 3 is a left side elevation view, showing the adjustable fluid tube and an illustration of the different angles the fluid flow can be directed.

FIG. 4 shows the fluid pipe assembly.

FIG. 5 shows some of the different roller cover types and how they fit on the rod assembly.

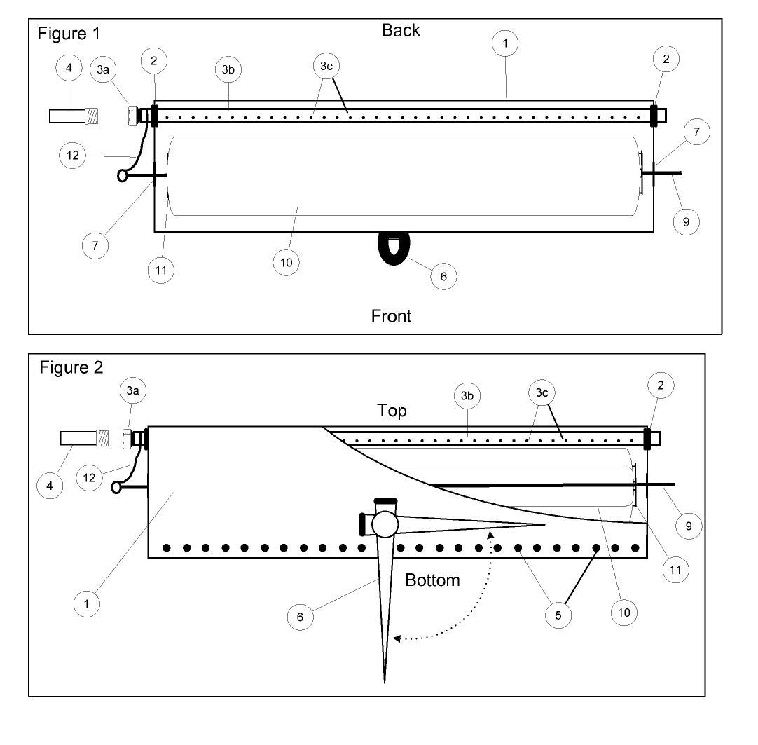

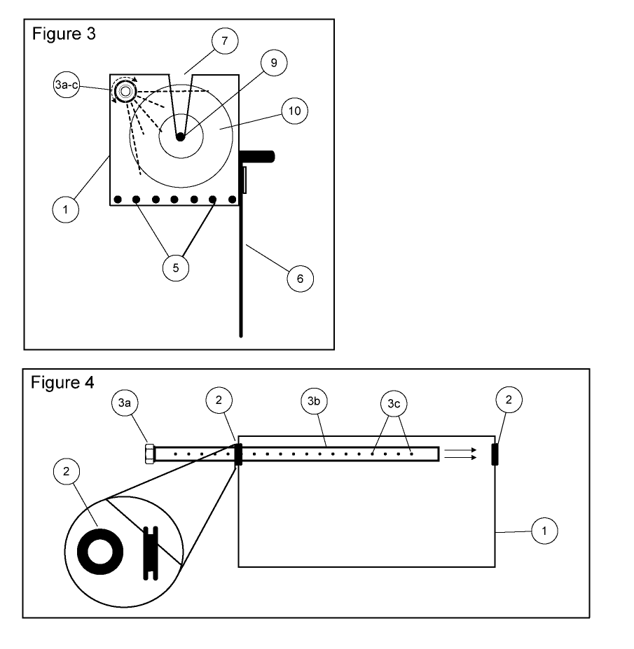

### DETAILED DESCRIPTION OF THE EMBODIMENTS

The apparatus includes an enclosure 1 with v-shape slots at each end for mounting 7. The purpose of the enclosure is to cradle the roller shaft 9 and to house the fluid pipe 3a-c. Around the bottom of the enclosure are openings 5, to allow the flow of excess fluid to exit the enclosure 1. The enclosure's mounting slot 7 supports and allows the roller cleaner shaft 9 to be dropped into the slot easily. The shaft 9 also has an optional securing wire 12 that its only purpose it to keep from losing the shaft 2 or keep it from being left on the job site. The mounting slots 7 are cut about half the depth of the enclosure 1 to prevent the shaft 2 from being able to spin out.

An optional spike 6 can be attached to the enclosure 1 that can be rotated from a horizontal position to a vertical position. Once in the vertical position the spike can be pushed into the ground to keep the enclosure 1 keeping the enclosure stationary while in operation. Other methods of making the enclosure 1 stationary may be used, including changes to the enclosure 1 design itself.

The fluid pipe assembly 3a-c consists of a pipe 3b that slightly longer than the length of the enclosure 1. A female threaded connector 3a is attached to one end of the fluid pipe 3b to allow a typical garden hose 4 to be attached to provide the water source. Along the fluid pipe are pluralities of holes 3c that are space approximately 1/16 inches apart. These holes 3c are drilled ¼ inches diameter along the length of the fluid pipe 3b slightly less that the length of the enclosure 1. In the remaining description the reference to the entire fluid pipe assembly 3a,b,c will be referred to as 3. The fluid pipe 3 is inserted into the enclosure through special rubber seals 2 that allow the fluid pipe to be inserted tightly into the enclosure 1. In FIG. 4, a magnified view is shown of the rubber seals. The tightness of the seals 2 allow the rotated clockwise or counter clockwise to direct the flow of the water onto the roller covers 10.

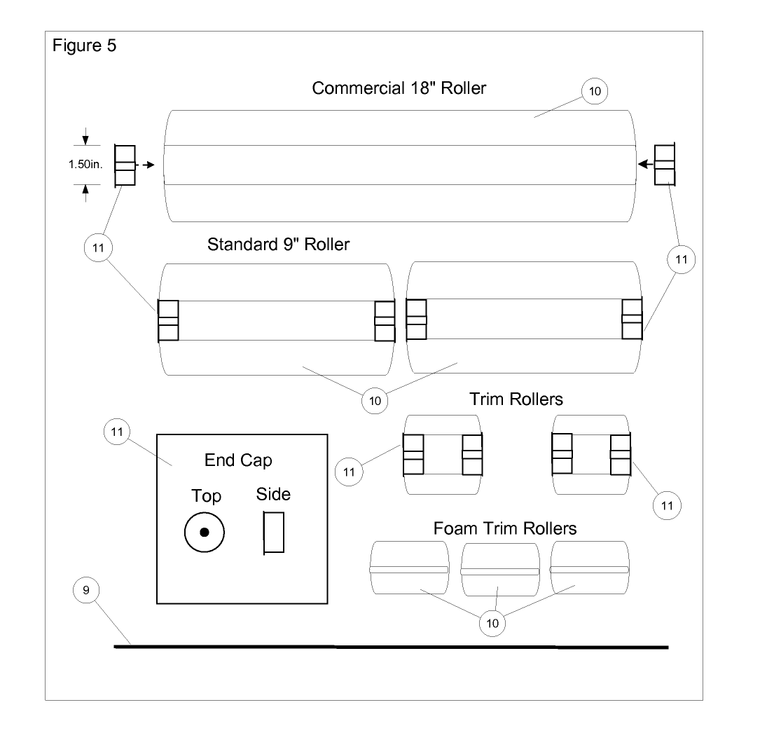

To start cleaning, a roller cover 10 can be removed from the paint roller. If the internal core opening of the cover is larger than ¼ inch an end cap 11 is place into the openings at each end to allow the shaft to be centered onto the roller shaft 9. End caps 2 for traditional size roller cover can be purchased from most paint stores. Additional end caps 111 may be made to accommodate non traditional size roller covers 10. After the roller cover 10 or multiple covers have been place on the shaft assembly, it can be placed into the enclosure 1. FIG. 5, shows some of the different types of rollers and the use of the end caps.

The fluid pipe 3 manages the flow of the fluid for the purpose of washing the cover 10. To activate the cleaning cycle, the external fluid source 4 has to be turned on. The fluid flow is directed through the fluid pipe 3b and is forced through the plurality of holes 3c down the entire length of the pipe that directs the pressurized fluid at an angle across the axis of the roller cover 10. The operator can adjust the angle by simple turning the fluid pipe 3 in any angle they desire. By directing the fluid pipe 3 flow across the outside axis of the roller, a faster spin may be achieved. Directing the fluid pipe 3 sprays closer to the center will allow for deeper penetration and cleaning using the fluids, but yield a slower spin. This directional spray is also necessary to accommodate different thicknesses or diameters of roller covers 10. If the operator is planning on not coming back for an extended period of time, an off-the-shelve hose timer may be placed between the external fluid source 4 and the incoming fluid pipe 3b to allow a length of time to be set for the fluid flow. It may be desired to adjust the angle of spray to the outside edge of the roller cover after the roller cover is clean to increase the spin and to expel the excess fluid. Thinner nap rollers can be completely cleaned in less than 2 minutes.

While this invention has been described in connection with preferred embodiments thereof, it is obvious that modifications and changes therein may be made by those skilled in the art to which it pertains without departing from the spirit and scope of the invention. For example, it would be obvious to replace the enclosure with a different shape and use a different method other than a spike to make the enclosure stationary.

What is claimed is:

1. A paint roller cover washer system, comprising of an enclosure that is slotted on each end to allow a rod shaft to be sit length wise through the enclosure; the enclosure also has drainage holes around the bottom side of the enclosure to allow fluid to drain from the invention; and a fluid pipe inserted through the length of the enclosure that will allow the fluid to pass through and spray out a plurality of small holes along the inside of the enclosure.

2. A paint roller cover washer system according to claim 1 where in the fluid pipe is adjustable and can be turned vertically thus changing the angle and impact of fluid to the roller cover.
